(19) United States
(12) Patent Application Publication
(10) Pub. No.: US 2010/0161925 A1
(43) Pub. Date: Jun. 24, 2010

(54) Information processing apparatus, information processing method, and computer-readable recording medium having an information processing program

(75) Inventor: Hisanori Kawaura, Kanagawa (JP)

Correspondence Address: Harness, Dickey & Pierce P.L.C., P.O. Box 8910, Reston, VA, 20195, US

(73) Assignee: Ricoh Company, Ltd.

(21) Appl. No.: 12/654,394

(22) Filed: Dec. 18, 2009

(30) Foreign Application Priority Data
Dec. 22, 2008 (JP) 2008-325944

(51) Int. Cl. G06F 12/16

(52) U.S. Cl. 711/162; 711/E12.103

(57) ABSTRACT

An information processing apparatus includes a first storage unit; a second storage unit connected to the first storage unit via a data transfer channel; a HDD total capacity determination unit acquiring information about a total storage capacity of the first storage unit; a HDD partition capacity determination unit acquiring information about a storage capacity in use of the second storage unit; a comparison unit comparing the total storage capacity of the second storage unit with the storage capacity in use of the second storage unit; a copy determination unit determining whether data stored in the second storage unit can be transferred to the first storage unit based on a result of comparison by the comparison unit; and a copy processing unit transferring the data stored in the second storage unit to the first storage unit when it is determined by the copy determination unit that the transfer is possible.

### BACKGROUND OF THE INVENTION

1. Field of the Invention

The present invention generally relates to mirroring or copying of hard disk drives (HDD).

2. Description of the Related Art

Conventionally, in an information processing apparatus, such as a personal computer (PC), an operating system (OS) is activated following the turning-on of power, providing an operating environment for the various functions (applications) of the PC. The mode in which the information processing apparatus is started up (“startup mode”) generally includes a normal mode and a safe mode. The normal mode is the startup mode in which the user can utilize all of the functions of the apparatus without limitations. The safe mode, on the other hand, is the startup mode that may be activated when an operation of the apparatus is destabilized for one reason or another, such as by an erroneous system setting. The safe mode may also be activated when the apparatus needs maintenance. In the safe mode, the number of modules that are started up is typically reduced compared to the normal mode, and a minimum number of functions is provided.

Thus, if a malfunction develops in the system, the information processing apparatus can be started up in the safe mode, so that a stable-function-providing environment can be restored by finding and eliminating the cause of the malfunction.

Japanese Laid-Open Patent Application No. 2004-334679 discloses an information processing apparatus including a module selecting unit for selecting one or more of a plurality of modules in the system that are activated when the apparatus is started up in the safe mode, thus providing a minimally configured system environment with a certain degree of freedom.

In a known method of eliminating the cause of a malfunction in the safe mode of an information processing apparatus, certain data in a storage unit of the apparatus may be erased. For example, Japanese Laid-Open Patent Application No. 2005-354671 discloses an information processing apparatus having a determination unit for determining whether the apparatus has been started up in a mode for erasing data in a storage unit of the apparatus. Depending on the result of such determination and relevant settings, the data is erased, thus efficiently erasing the data in the storage unit.

However, conventional information processing apparatuses such as those mentioned above are disadvantageous in that, for example, they do not permit mirroring if the capacity of a HDD purchased for mirroring purposes is smaller than the actual storage capacity of an existing HDD in operation.

Another problem is that it may not be possible to implement mirroring with a HDD whose capacity is smaller than the actual storage capacity of the existing HDD in operation due to the size of a created partition, even though the HDD in operation has not used up all of its free areas.

### SUMMARY OF THE INVENTION

The disadvantages of the prior art may be overcome by the present invention which, in one aspect, is an information processing apparatus including a first storage unit; a second storage unit connected to the first storage unit via a data transfer channel; a HDD total capacity determination unit configured to acquire information about a total storage capacity of the first storage unit; a HDD partition capacity determination unit configured to acquire information about a storage capacity in use of the second storage unit; a comparison unit configured to compare the information about the total storage capacity of the second storage unit acquired by the HDD total capacity determination unit with the information about the storage capacity in use of the second storage unit acquired by the HDD partition capacity determination unit; a copy determination unit configured to determine whether data stored in the second storage unit can be transferred to the first storage unit based on a result of comparison by the comparison unit; a copy processing unit configured to transfer the data stored in the second storage unit to the first storage unit when it is determined by the copy determination unit that the transfer is possible.

According to another aspect of the present invention, an information processing method includes acquiring information about a total storage capacity of a first storage unit; acquiring information about a storage capacity in use of a second storage unit; comparing the information about the total storage capacity of the first storage unit with the information about the storage capacity in use of the second storage unit; determining whether data stored in the second storage unit can be transferred to the first storage unit based on a result of the comparing step; and transferring the data stored in the second storage unit to the first storage unit when it is determined in the determining step that the data can be transferred.

According to another aspect of the present invention, a computer-readable recording medium stores an information processing program which, when executed by one or more processors of an information processing apparatus, carries out: acquiring information about a total storage capacity of a first storage unit; acquiring information about a storage capacity in use of a second storage unit; comparing the information about the total storage capacity of the first storage unit with the information about the storage capacity in use of the second storage unit; determining whether data stored in the second storage unit can be transferred to the first storage unit based on a result of the comparing step; and transferring the data stored in the second storage unit to the first storage unit when it is determined in the determining step that the data can be transferred.

### BRIEF DESCRIPTION OF THE DRAWINGS

Other objects, features and advantages of the present invention will become apparent upon consideration of the specification and the appendant drawings, in which:

FIG. 1 depicts a hardware configuration of an information processing apparatus according to an embodiment of the present invention;

FIG. 2 depicts a software configuration of the information processing apparatus of the present embodiment;

FIG. 3 depicts a structure of a memory area of a ROM in the present embodiment;

FIG. 4 depicts a software configuration of a safe mode function executing module according to the present embodiment;

FIG. 5 depicts a block diagram of a software structure for performing a HDD mirroring process;

FIG. 6 depicts a sequence diagram of a HDD information acquisition process performed by a copy determination unit;

FIG. 7 depicts a flowchart of a copy execution determination process performed by a copy determination unit after the HDD information acquisition process;

FIG. 8 depicts a flowchart of a HDD copy process <1> performed by a copy process unit;

FIG. 9 depicts a flowchart of an end process performed by a copy determination unit;

FIG. 10 depicts a flowchart of an error process <1> performed by the copy determination unit;

FIG. 11 depicts a flowchart of a progress display process <1> performed by a HDD transfer time predicting unit;

FIG. 12 depicts a flowchart of a HDD-capacity-changing copy process performed by the copy process unit;

FIG. 13 depicts a flowchart of a partition copy process performed by the copy process unit;

FIG. 14 depicts a flowchart of a partition-size-changing copy process performed by the copy process unit;

FIG. 15 depicts a flowchart of a HDD copy process <2> performed by the copy process unit;

FIG. 16 depicts a flowchart of an error process <2> performed by the copy determination unit;

FIG. 17 depicts a flowchart of a progress display process <2> performed by a HDD transfer time predicting unit; and

FIG. 18 depicts a flowchart of a progress display process <3> performed by the HDD transfer time predicting unit.

### DETAILED DESCRIPTION OF THE PREFERRED EMBODIMENTS

### Hardware Configuration

Embodiments of the present invention are described below referring to the drawings. The same reference numerals designate identical or corresponding parts throughout.

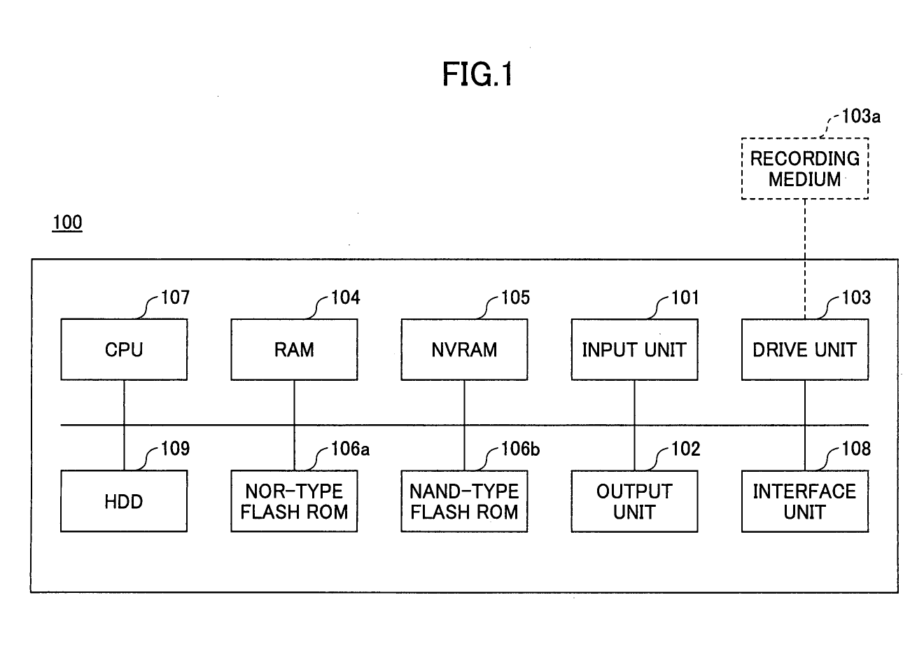

Referring to FIG. 1, a hardware configuration of an information processing apparatus 100 according to an embodiment of the present invention is described. The information processing apparatus 100 includes an input unit 101, a output unit 102, a drive unit 103, a RAM (random access memory) 104, a NVRAM (non-volatile RAM) 105, a NOR flash ROM (read only memory) 106a, a NAND flash ROM 106b, a CPU (central processing unit) 107, an interface unit 108, and a HDD (hard disk drive) 109. The units of the information processing apparatus 100 are connected via a bus.

The input unit 101 may include a keyboard and mouse and may be used for entering various operating signals into the information processing apparatus 100. The output unit 102 may be used for displaying a result of processing by the information processing apparatus 100. The interface unit 108 provides an interface for connecting the information processing apparatus 100 to a data transmission channel (not depicted), such as a network. The information processing apparatus 100 may perform data communications with an external device via the interface unit 108. The HDD 109 may store programs and data related to applications for providing various functions of the information processing apparatus 100 (such as a document/image editing function and a data communication function). The programs or data stored in the HDD 109 may be managed using a file system 310, which will be described later, and a database which is not depicted.

The aforementioned programs and data may be provided to the information processing apparatus 100 via a recording medium 103a, such as a CD (Compact Disk). Alternatively, they may be downloaded via a data transmission channel, such as a network. When provided via the recording medium 103a, the programs and data may be installed on the HDD 109 via the drive unit 103 configured to read the recording medium 103a.

The NVRAM 105 and the flash ROMs 106a and 106b are rewritable, non-volatile semiconductor memories capable of retaining internal data when power is turned off. The NVRAM 105 and the flash ROMs 106a and 106b may be configured to store various programs, such as a BIOS (Basic Input/Output System) program that is run upon startup of the information processing apparatus 100, and other programs for controlling the information processing apparatus 100 as a whole to provide an information processing system. The NVRAM 105 and the flash ROMs 106a and 106b may also store data concerning system settings or network-related settings of the information processing apparatus 100. The RAM 104 may temporarily store programs or data read from any of the aforementioned various storage units. The CPU 107 may execute a program temporarily stored in the RAM 104.

In the above-described hardware configuration of the information processing apparatus 100, an application program may be read from the HDD 109 onto the RAM 104 and then executed by the CPU 107 in order to allow the viewing or editing of documents or image data, or perform data communications between the information processing apparatus 100 and an external device via the interface unit 108.

### <Software Configuration>

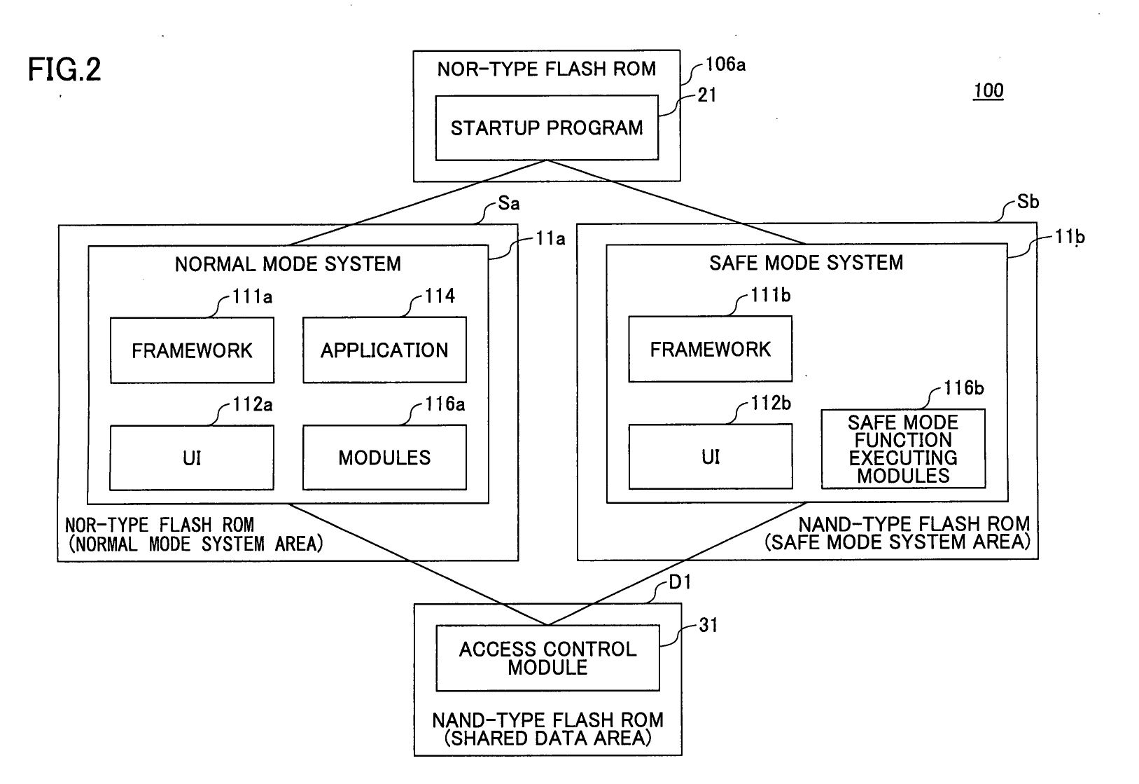

FIG. 2 depicts a software configuration of the information processing apparatus 100 according to the present embodiment. As depicted in FIG. 2, the information processing apparatus 100 includes a normal mode system 11a and a safe mode system 11b. The normal mode system 11a is started up for normal operation. The safe mode system 11b is started up for system recovery, for example. Thus, the information processing apparatus 100 has a dual information processing system structure.

The normal mode system 11a includes a framework 111a for an operation of an application 114; the application 114; a UI (user interface) 112a providing an interface between a user and the information processing system 100; and a group of modules 116a related to the application 114 for providing the various functions of the information processing system to the user. On the other hand, the safe mode system 11b includes a framework 111b, a UI 112b, and a safe mode function executing module 116b. The safe mode function executing module 116b will be described in detail later.

Startup of the normal mode system 11a and the safe mode system 11b is controlled by a startup program 21, which may be referred to as a “boot loader” or a “boot-strap”. The startup program 21 may control the starting-up of the systems 11a and 11b based on the setting of a startup flag retained in the NVRAM 105. The startup flag may be set for either the normal mode 20 or the safe mode. The startup flag may consist of one bit, with each startup mode being associated with either the logical “0” or “1” in advance. Thus, the starting up of the normal mode system 11a or the safe mode system 11b can be controlled by the startup program 21 based on the startup flag setting.

The information processing apparatus 100 further includes an access control module 31. The access control module 31 may control accessing (such as reading and writing) of data retained in a storage unit, such as the RAM 104, the NAND flash ROM 106b, or the HDD 109, from a module in either the normal mode system 11a or the safe mode system 11b, by identifying an access destination (where the relevant data is stored) based on the accessed data, the accessing module, or the startup mode. Namely, the modules 116a and 116b in the respective systems 11a and 11b access data via the access control module 31.

### <Memory Area>

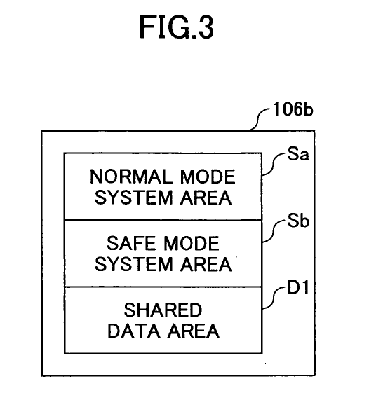

FIG. 3 illustrates a structure of a memory area in the NAND flash ROM 106b according to the present embodiment. The memory area in the ROM 106b is roughly divided into a system area and a shared data area D1 (see also FIG. 2). The system area may include a normal mode system area Sa to which the normal mode system 11a is allocated, and a safe mode system area Sb to which the safe mode system 11b is allocated. The shared data area D1 is shared by both of the normal mode system 11a and the safe mode system 11b.

### <Safe Mode Function Executing Module>

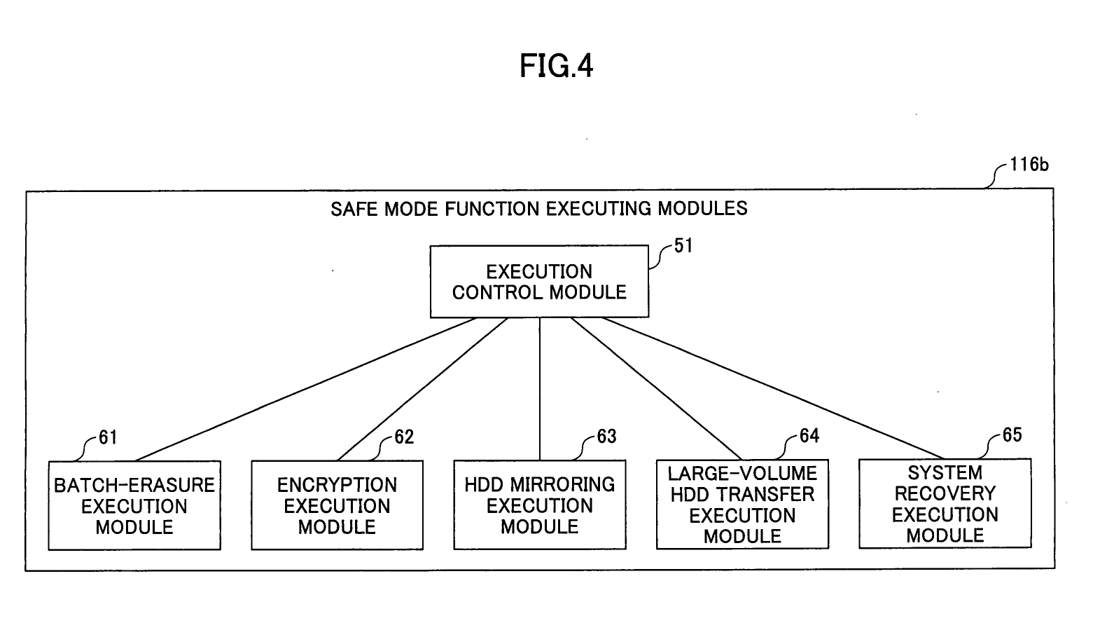

FIG. 4 illustrates a software configuration of the safe mode function executing module 116b according to the present embodiment. The safe mode function executing module 116b includes an execution control module 51; a batch-erasure executing module 61; an encryption executing module 62; a HDD mirroring executing module 63; a large-volume-HDD transfer executing module 64; and a system recovery executing module 65.

The execution control module 51 provides the function of determining which one of the executing modules 61 through 65 should be executed (i.e., which function of the executing modules 61 through 65 should be activated). The execution control module 51 may be configured to determine which one of the executing modules 61 through 65 should be executed based on the setting of the execution flag. The execution control module 51 may also perform an exclusive control or a coordination control for the executing modules 61 through 65. The coordination control may involve performing a batch-erasure of a HDD #0 as a primary disk, after a large-volume-HDD data transfer process.

The executing modules 61 through 65 controlled by the execution control module 51 are described in detail below. The batch-erasure executing module 61 provides the function of batch-erasing data stored in a predetermined memory area. The “erasing” herein is intended to refer to overwriting the data using random numbers, for example, to render the data unreadable (unrecoverable), rather than deleting the data from the memory area.

The encryption executing module 62 provides the function of generating an encryption key, encrypting the encryption key (i.e., re-encrypting the key to render an encrypted text into a different encrypted text), or decrypting the encryption key. The HDD mirroring executing module 63 provides the function of mirroring the data stored in a predetermined memory area (i.e., creating a duplicate of the written data in another memory area for duplexing).

The large-volume-HDD transfer executing module 64 provides the function of copying data from the primary disk HDD #0 to a secondary disk HDD #1. The system recovery executing module 65 provides the function of repairing a damaged location within the system 11a or 11b and compulsorily re-installing the system 11a or 11b using a recovery CD, for example.

The executing modules 61 through 65 are controlled by the execution control module 51, whereby the safe mode function of the information processing apparatus 100 can be realized. More specifically, the safe mode function is realized when any of the aforementioned modules is read from the NAND flash ROM 106b onto the RAM 104 and then executed by the CPU 107.

### <Structure for Performing HDD Mirroring>

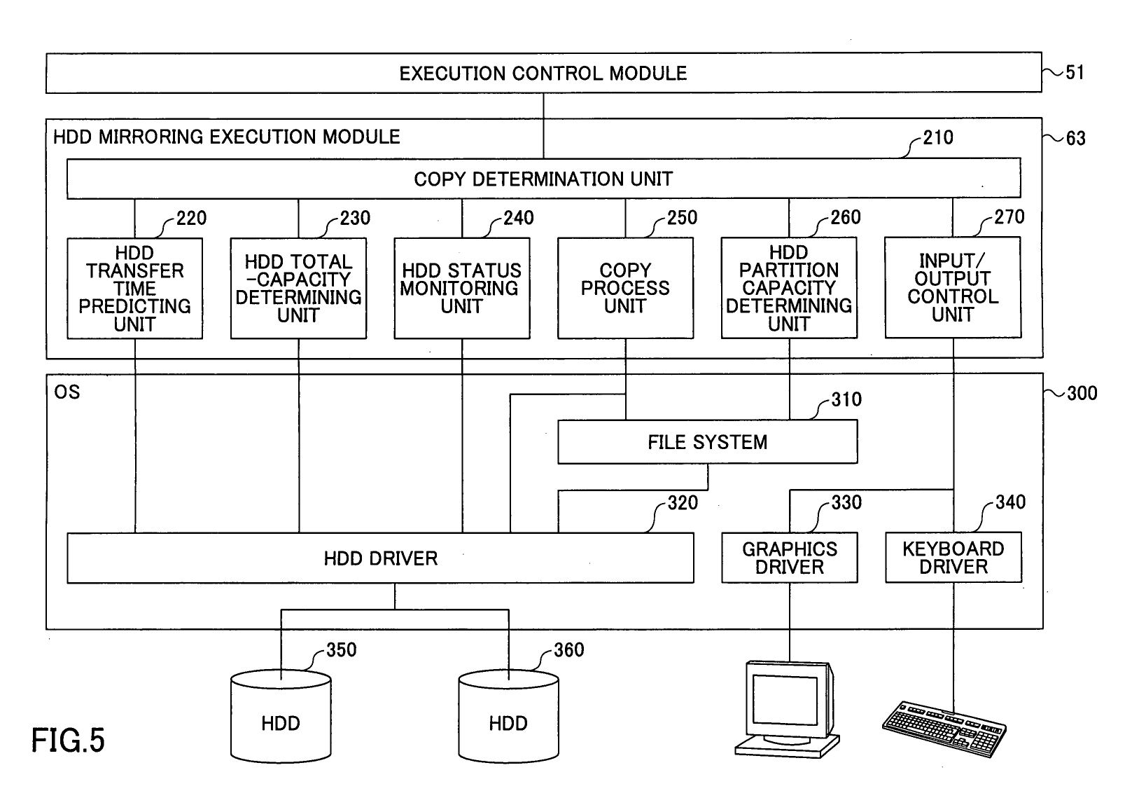

FIG. 5 depicts a block diagram of a software configuration for performing HDD mirroring. The HDD mirroring executing module 63 includes a copy determination unit 210; a HDD transfer time predicting unit 220; a HDD total capacity determining unit 230; a HDD status monitoring unit 240; a copy process unit 250; a HDD partition capacity determining unit 260; and an input/output control unit 270.

The copy determination unit 210 determines whether HDD mirroring should be performed. The HDD transfer time predicting unit 220 predicts when HDD mirroring will be completed. The HDD total capacity determining unit 230 queries a HDD regarding its total storage capacity. Specifically, when the HDD is of the ATA interface standard, for example, the HDD total capacity determining unit 230 may issue an IdentifyCommand and acquire an LBA (logical block addressing) value.

The HDD status monitoring unit 240 may monitor HDD access and notify the copy determination unit 210 if there is a HDD access error. The copy process unit 250 may perform a HDD mirroring executing process in accordance with instructions from the copy determination unit 210. The HDD partition capacity determining unit 260 may acquire information about the number of partitions in the HDD, the storage capacity allocated to each partition, and a storage capacity in use with regard to each partition. The input/output control unit 270 may control a graphics driver 330 and a keyboard driver 340, may control the display of a HDD mirroring execution status, or accept a termination request.

The OS 300 includes a HDD driver 320; a file system 310; the graphics driver 330; and the keyboard driver 340. The HDD driver 320 may issue an ATA Command in the case of an ATA interface standard HDD, and perform read/write access control with respect to a HDD 350 or a HDD 360. The file system 310 performs file control on the HDD 350 or 360 using a file management system, such as an FFS (Fast File System) implemented on the HDD 350 or the HDD 360. The graphics driver 330 performs image display control for a display unit such as a CRT (cathode-ray tube) unit.

The keyboard driver 340 receives key inputs via a keyboard.

### <Procedure>

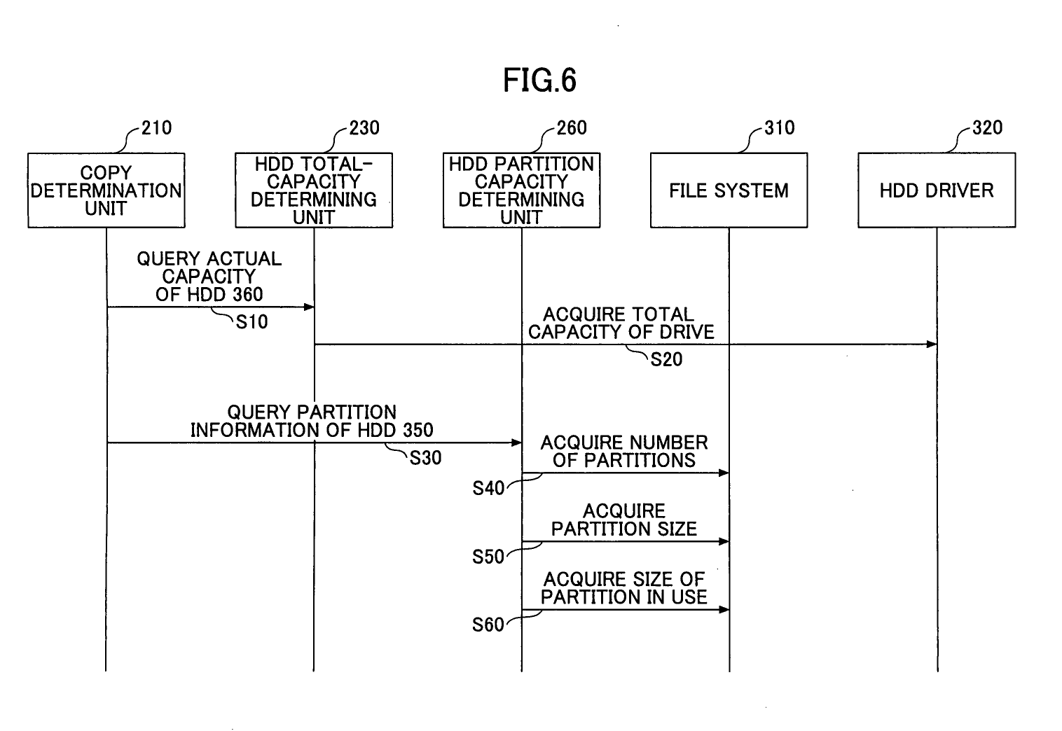

In the following, a procedure for performing mirroring from the HDD 350 to the HDD 360 using the above-described HDD mirroring structure is described. FIG. 6 depicts a sequence diagram of a HDD information acquisition process performed by the copy determination unit 210 when the HDD mirroring executing module 63 is started up by the execution control module 51.

First, the copy determination unit 210 queries the HDD total capacity determining unit 230 about the actual storage capacity of the HDD 360 (S10). The HDD total capacity determining unit 230 then acquires the total storage capacity of the HDD 360 via the HDD driver 320 (S20). The copy determination unit 210 queries the HDD partition capacity determining unit 260 about the partition information of the HDD 350 (S30). The HDD partition capacity determining unit 260 obtains a disk label from the file system 310, and determines the number of partitions (S40), the size of each partition (i.e., the storage capacity allocated to each partition) (S50), and the size in use (i.e., the storage capacity being used within each partition) (S60).

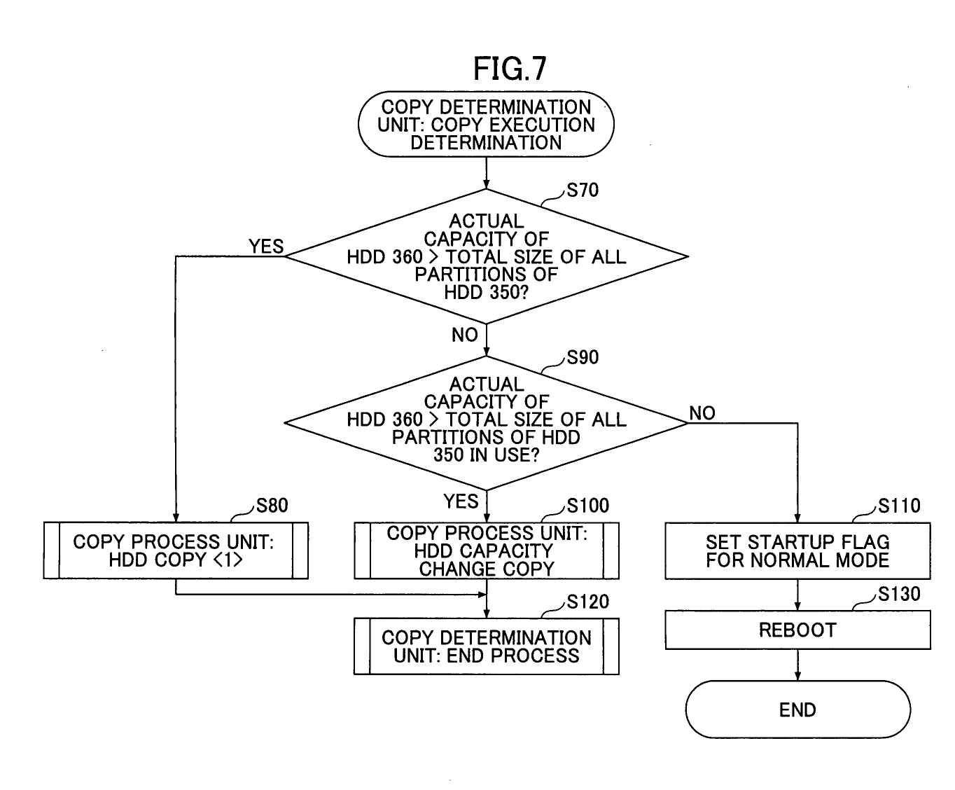

FIG. 7 depicts a flowchart of a copy execution determination process following the HDD information acquisition process performed by the copy determination unit 210. First, it is determined whether the actual storage capacity of the HDD 360 is greater than the total size of all of the partitions of the HDD 350 (S70). If the result of the determination is YES, a request for a HDD copy process <1> that copies the HDD 350 to the HDD 360 is sent to the copy process unit 250 (S80). The HDD copy process <1> will be described in detail below.

If the result of the determination in S70 is No, it is determined in step S90 whether the actual storage capacity of the HDD 360 is greater than the total size of all of the partitions of the HDD 350 being used. If so, a request for a HDD-capacity-changing copy process that changes the capacity of each of the HDD 350 and the HDD 360 is sent to the copy process unit 250 (S100). After the HDD copy process <1> or the HDD-capacity-changing copy process, an end process is performed (S120). If the actual storage capacity of the HDD 360 is smaller than the total size of all of the partitions of the HDD 350 being used (“No” in S90), the startup flag is changed to the normal mode (S110) and the system is rebooted (S130), thus interrupting the operation of the information processing apparatus once and resuming it in the normal mode.

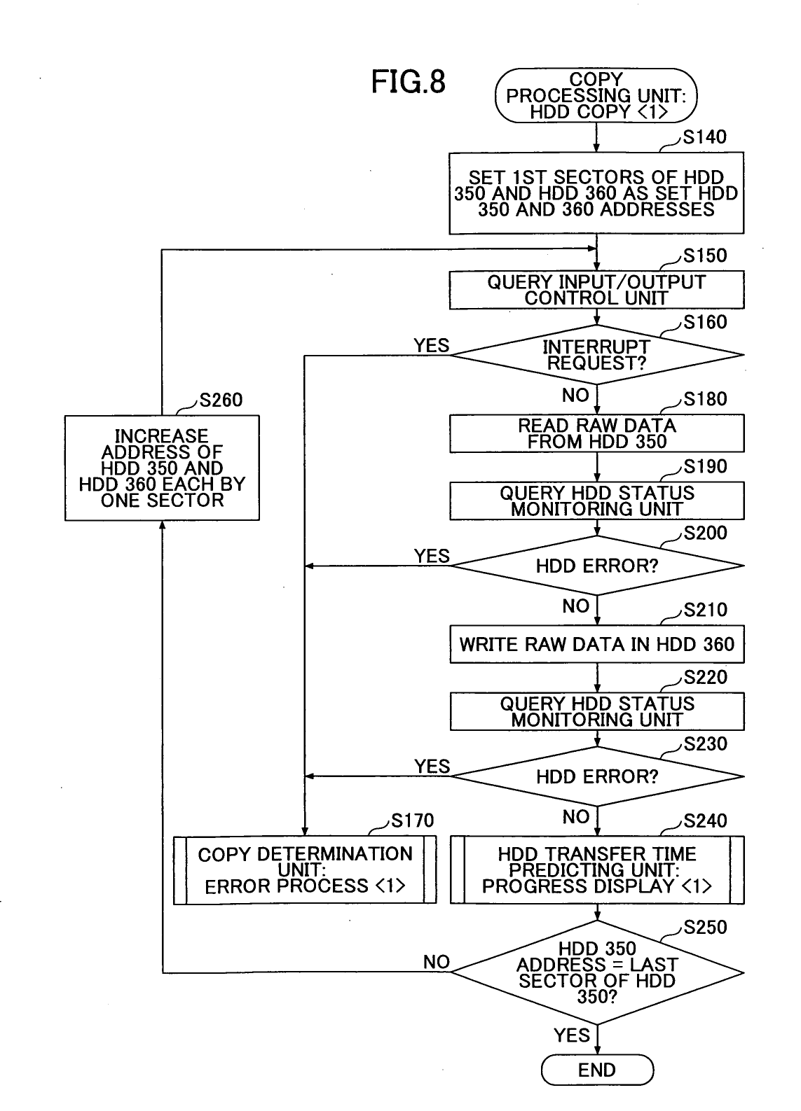

FIG. 8 depicts a flowchart of the HDD copy process <1> performed by the copy process unit 250. First, the first sectors of the HDD 350 and the HDD 360 are set as a set HDD 350 address and a set HDD 360 address, respectively (S140). Then, a query is sent to the input/output control unit 270 (S150) to determine whether there is a termination request via the keyboard (S160). If there is a termination request, a request for an error process <1> is sent to the copy determination unit 210 (S170). If there is no termination request (“No” in S160), the raw data written in the set HDD 350 address is read (S180), and then written in the set HDD 360 address (S210).

In each of the processes of reading and writing data, the HDD status monitoring unit 240 is queried about the presence of a HDD access error (S190, S220). If there is an access error (“Yes” in S200 or S230), an error process request is sent to the copy determination unit 210. If no HDD access error is found in both S200 and S230, a request for a progress display process is sent to the HDD transfer time predicting unit 220 (S240). The above cycle is repeated until the set HDD 350 address reaches the final sector of the HDD 350 (S250, S260).

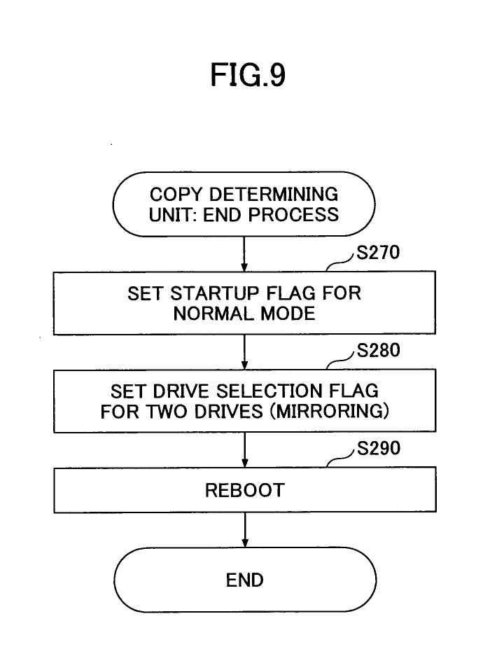

FIG. 9 depicts a flowchart of the end process performed by the copy determination unit 210.

First, the startup flag is set to the normal mode (S270). Then, a drive selection flag is set for mirroring of two units (S280). Finally, reboot is performed (S290). In this way, the information processing apparatus 100 after rebooting can perform normal mirroring.

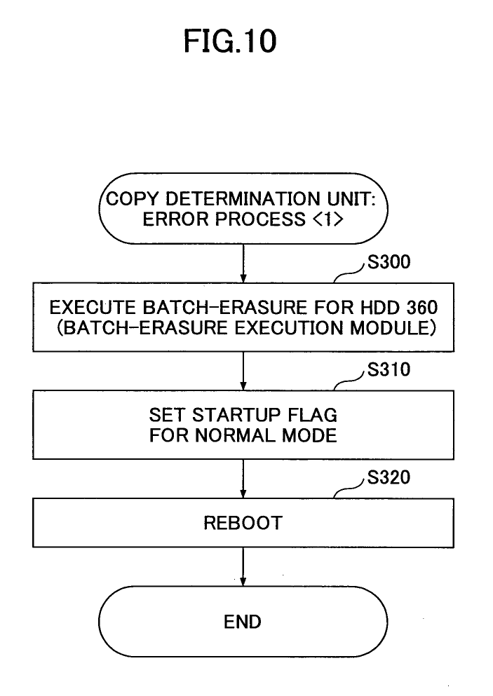

FIG. 10 depicts a flowchart of the error process <1> performed by the copy determination unit 210. First, the batch-erasure executing module 61 is started up for the HDD 360, and a batch-erasure is performed (S300). The startup flag is then changed to the normal mode (S310). Finally, rebooting is performed (S320). In this way, the data that has been transferred to the HDD 360 in an incomplete state can be deleted, followed by rebooting of the information processing apparatus 100.

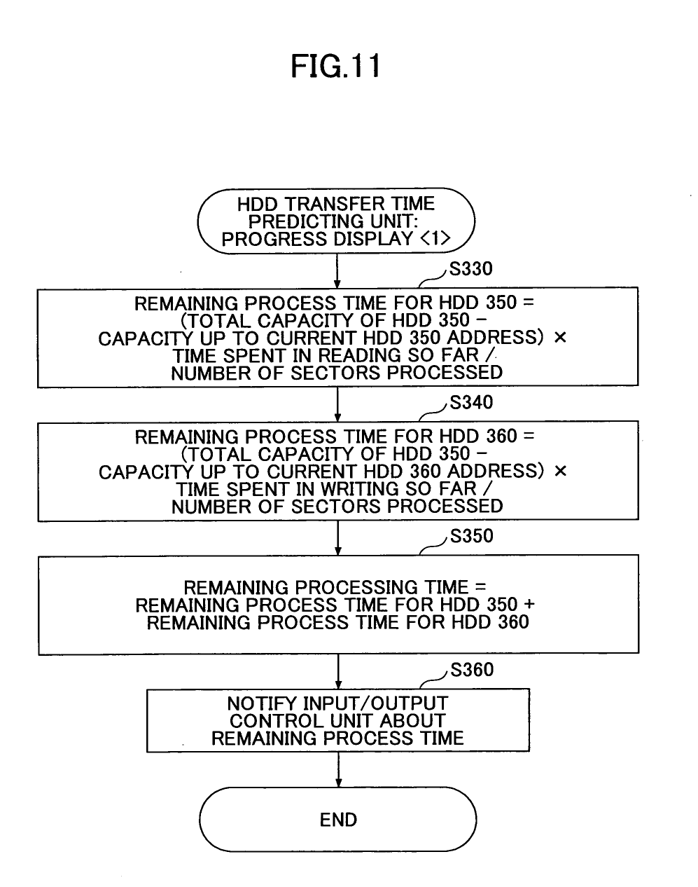

FIG. 11 depicts a flowchart of the progress display process performed by the HDD transfer time predicting unit 220. First, a remaining process time with respect to the HDD 350 is calculated as follows. The storage capacity up to the current set HDD 350 address is subtracted from the total storage capacity of the HDD 350. The resultant difference is divided by the number of sectors that have been read since the start of the process up to the present time. Then, the quotient is multiplied by the time that has elapsed since the start of the process (S330).

The remaining process time of the HDD 360 is calculated as follows. The storage capacity up to the current set HDD 360 address is subtracted from the total storage capacity of the HDD 350, and the resultant difference is divided by the number of sectors that have been read since the start of the process up to the present time. The resultant quotient is then multiplied by the time that has elapsed since the start of the process (S340).

The remaining process time of the HDD 350 and the remaining process time of the HDD 360 are added, thus calculating a total remaining time of the mirroring process (S350). Finally, the input/output control unit 270 is notified about the thus calculated remaining time, and the progress status is displayed on the CRT or the like (S360).

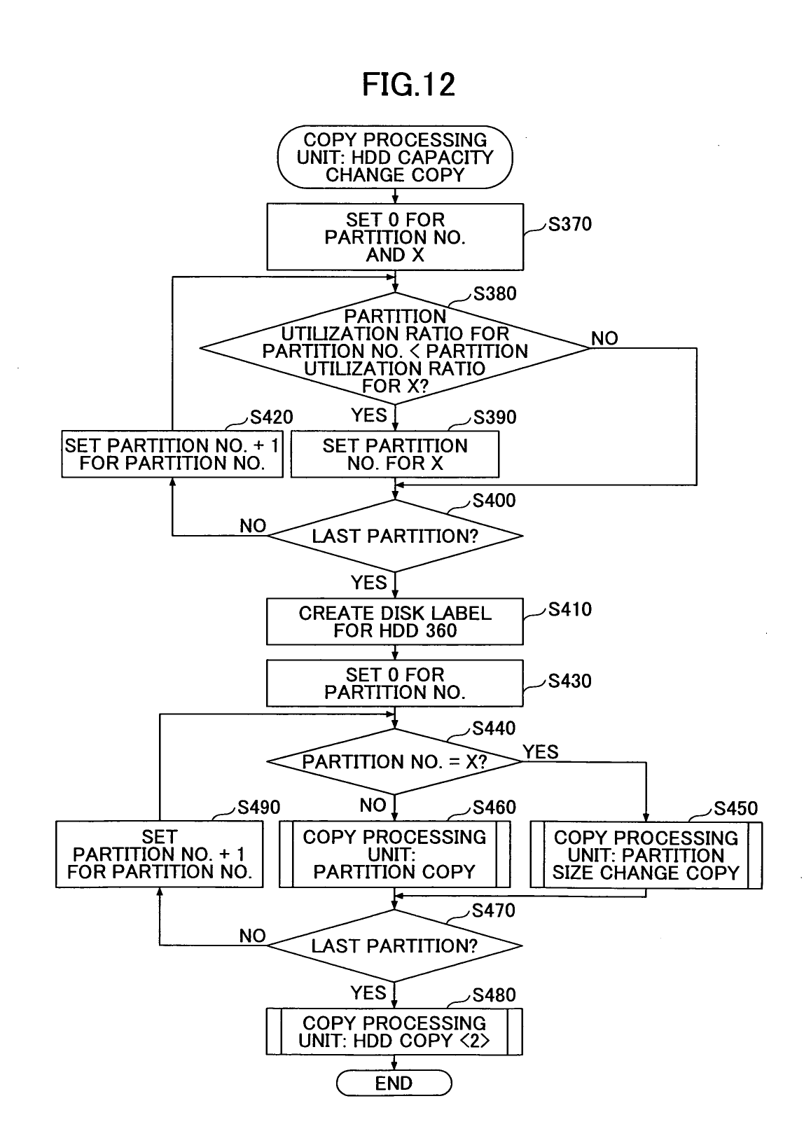

FIG. 12 depicts a flowchart of a HDD-capacity-changing copy process performed by the copy process unit 250. First, “0” is set for the partition number and a variable X (S370). Then, it is determined whether a partition utilization ratio for the partition number is smaller than a partition utilization ratio for the variable X (S380). If so (YES in S380), the value of the partition number is set for X (S380). This process is repeated for the number of partitions (S400, S420), whereby the partition having the lowest partition utilization ratio is determined as X.

A disk label in which the size of the partition of X is changed so that it can be stored in the HDD 360 is written in the HDD 360 (S410). Then, “0” is again set for the partition number (S430). If the partition number is X (“Yes” in S440), the partition-size-changing copy process is performed (S450); if not, the partition copy process is performed (S460). The above process is repeated for the number of the partitions (S470, S490). Finally, the HDD copy process <2> is performed to write the data of HDD 360 back in the HDD 350 (S480).

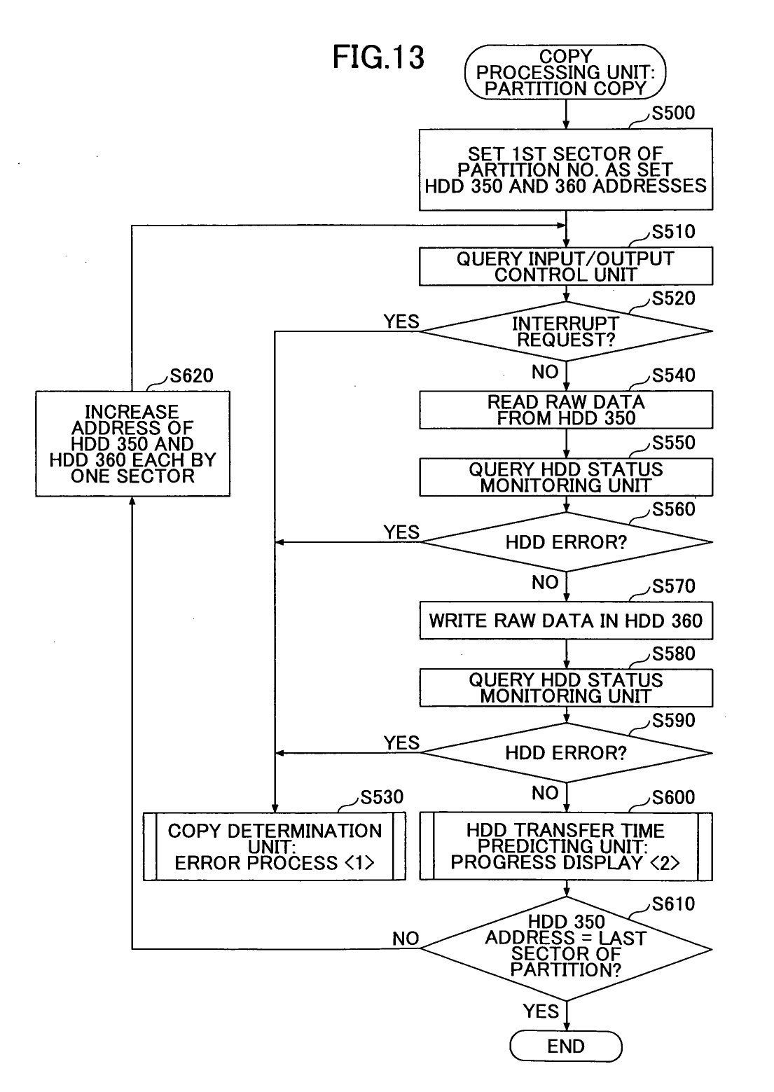

FIG. 13 depicts a flowchart of the partition copy process performed by the copy process unit 250. First, as a set HDD 350 address and a set HDD 360 address, the first sector of the partition corresponding to the partition number that is set in S430 or S490 in FIG. 12 is set (S500). Then, the input/output control unit 270 is queried about the presence or absence of a termination request via the keyboard (S510, S520). If there is a termination request (“Yes” in S520), an error process request is sent to the copy determination unit 210 (S530).

If there is no termination request (“No” in S520), the raw data written in the set HDD 350 address is read (S540), and the raw data is written in the set HDD 360 address (S570). In each of these processes of reading and writing, the HDD status monitoring unit 240 is queried about the presence or absence of a HDD access error (S550, S580). If there is an access error (“Yes” in either S560 or S590), a request for an error process <1> is sent to the copy determination unit 210 (S530). If there is no HDD access error in S590, a request for a progress display process <2> is sent to the HDD transfer time predicting unit 220 (S600). The above cycle is repeated until the set HDD 350 address reaches the last sector of the partition corresponding to the partition number that has been set in S430 or S490 of FIG. 12 (S610, S620).

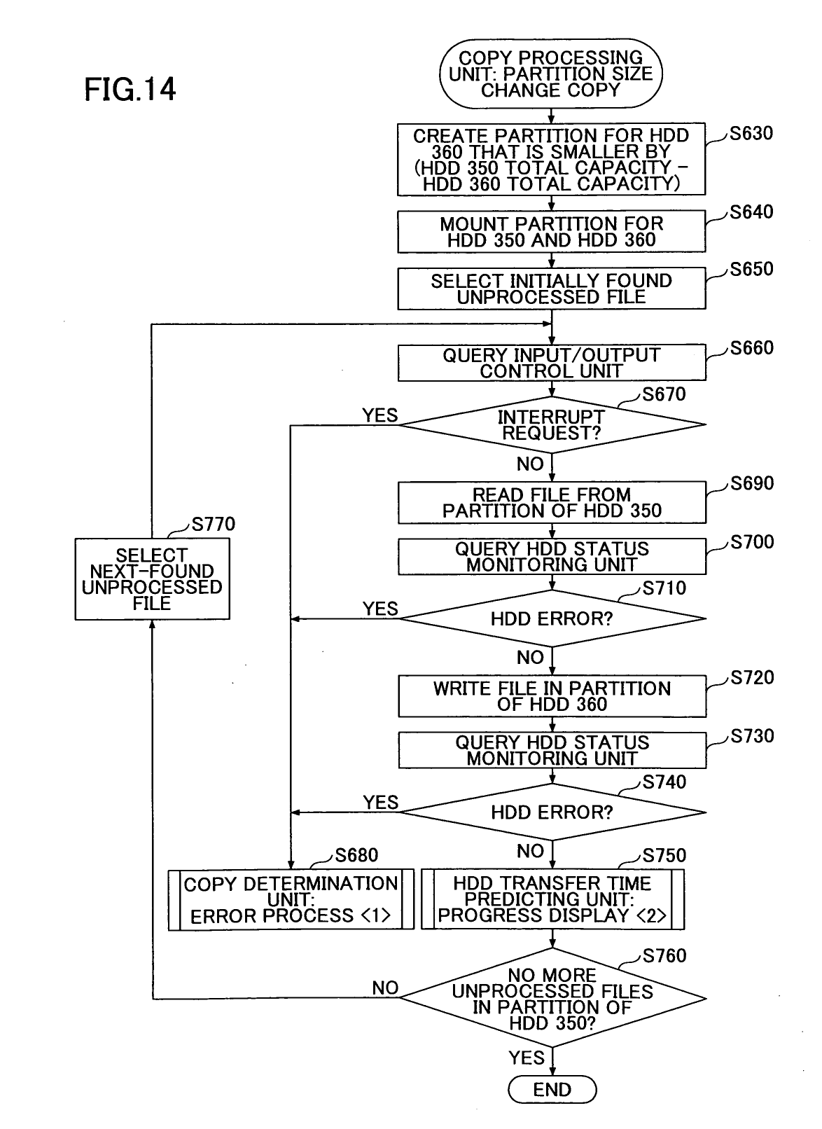

FIG. 14 depicts a flowchart of a partition-size-changing copy process performed by the copy process unit 250. First, a partition of the HDD 360 that corresponds to the partition number set in S430 or S490 is created, the partition having a storage capacity reduced by the difference between the total storage capacity of the HDD 350 and that of the HDD 360 (S630). Then, the partitions of the HDD 350 and the HDD 360 are mounted (S640).

Thereafter, the relevant partition of the HDD 350 is searched for a file, thus determining the first file to be processed (S650). The input/output control unit 270 is then queried about the presence or absence of a termination request via the keyboard (S660). If there is a termination request “Yes” in S670), a request for an error process <1> is sent to the copy determination unit 210 (S680). If there is no termination request (“No” in S670), the file is then read from the relevant partition of the HDD 350 (S690) and then written in the relevant partition of the HDD 360 (S720).

In each of these processes of reading and writing, the HDD status monitoring unit 240 is queried about the presence or absence of a HDD access error (S700, S730). If there is an access error (“Yes” in S700 or S740), a request for an error process <1> is sent to the copy determination unit 210 (S680). If there is no HDD access error in S740, a request for a progress display process <2> is sent to the HDD transfer time predicting unit 220 (S750). This cycle is repeated until there are no un-processed files in the relevant partition of the HDD 350 (S760, S770).

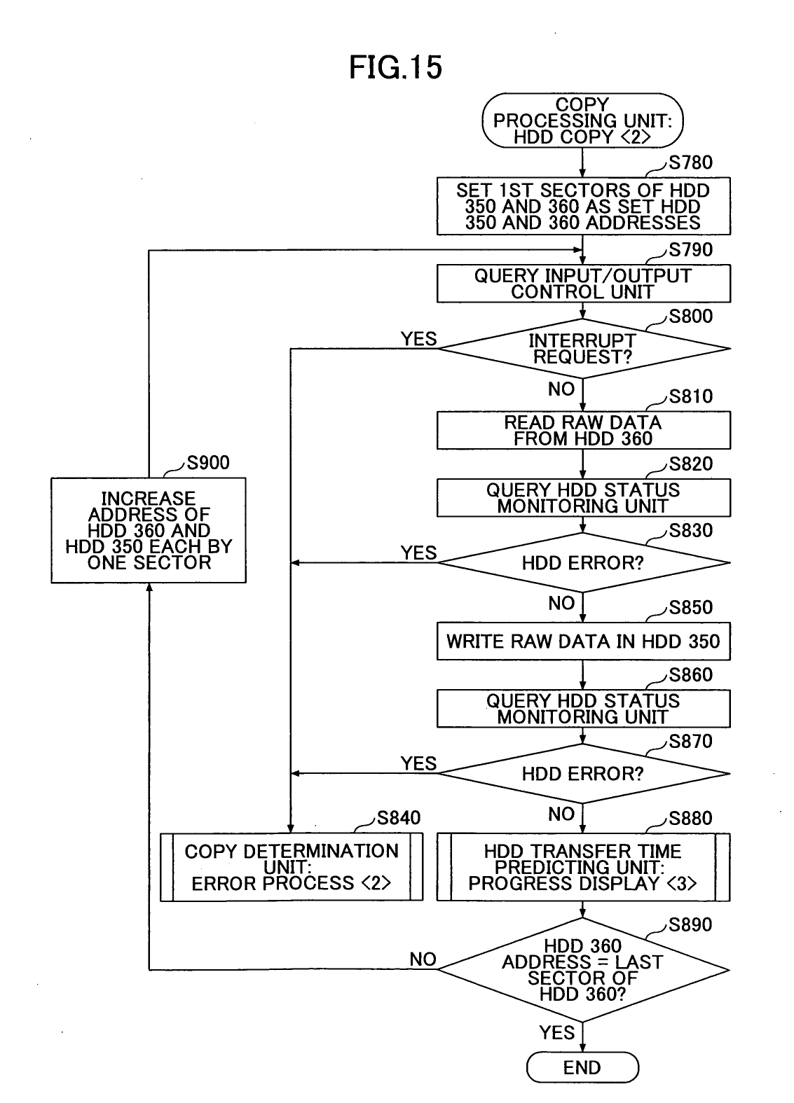

FIG. 15 depicts a flowchart of the HDD copy process <2> performed by the copy process unit 250. First, a first sector is set as a set HDD 360 address and a set HDD 350 address (S780). The input/output control unit 270 is then queried about the presence or absence of a termination request via the keyboard (S790). If there is a termination request (“Yes” in S800), an error process request is sent to the copy determination unit 210 (S840).

If there is no termination request (“No” in S800), the raw data in the set HDD 360 address is read (S810), and then written in the set HDD 350 address (S850). In each of the processes of reading and writing, the HDD status monitoring unit 240 is queried about the presence or absence of a HDD access error (S820, S860). If there is an access error (“Yes” in S830 or S870), a request for an error process <2> is sent to the copy determination unit 210 (S840). If there is no error in S870, a request for a progress display process <3> is sent to the HDD transfer time predicting unit 220 (S880). This cycle is repeated until the set HDD 360 address reaches the final sector of the HDD 360 (S890, S900).

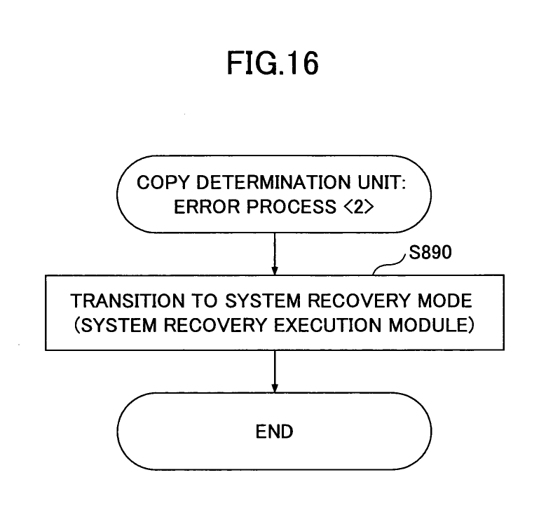

FIG. 16 depicts a flowchart of the error process <2> performed by the copy determination unit 210. In the error process <2>, the system transitions to a system recovery mode without exception (S890). If the HDD 350 has first been copied to the HDD 360 with a capacity change and then copying from the HDD 360 to the HDD 350 has failed, the recovery of the HDD 350 is given priority. Alternatively, the drive selection flag may be set for the HDD 360 alone, and the system may be rebooted after returning the startup flag to the normal mode, thus starting up the information processing apparatus 100 from the HDD 360. In this case, the data stored in the HDD 350 may be batch-erased.

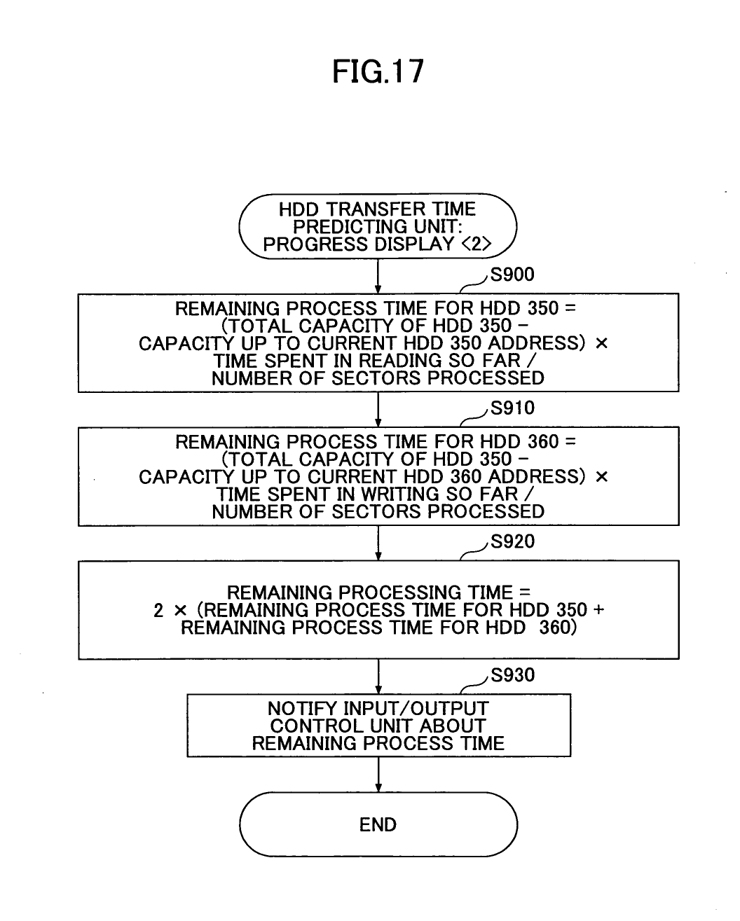

FIG. 17 depicts a flowchart of the progress display process <2> performed by the HDD transfer time predicting unit 220. First, the remaining process time of the HDD 350 is calculated as follows. The storage capacity up to the set HDD 350 address is subtracted from the total storage capacity of the HDD 350, and the difference is divided by the number of sectors that have been read up to the present time. The resultant quotient is then multiplied by the process time up to the present time (S900).

The remaining process time of the HDD 360 is calculated as follows. The storage capacity up to the set HDD 360 address is subtracted from the total storage capacity of the HDD 360, and the difference is divided by the number of sectors that have been read up to the present time. The resultant quotient is then multiplied by the process time up to the present (S910). Thereafter, the remaining process time of the HDD 350 and the remaining process time of the HDD 360 are added, and the sum is doubled, thereby obtaining a total remaining time of the mirroring process (S920). Finally, the input/output control unit 270 is notified of the calculated remaining time, and a progress status is displayed on the CRT or the like (S930).

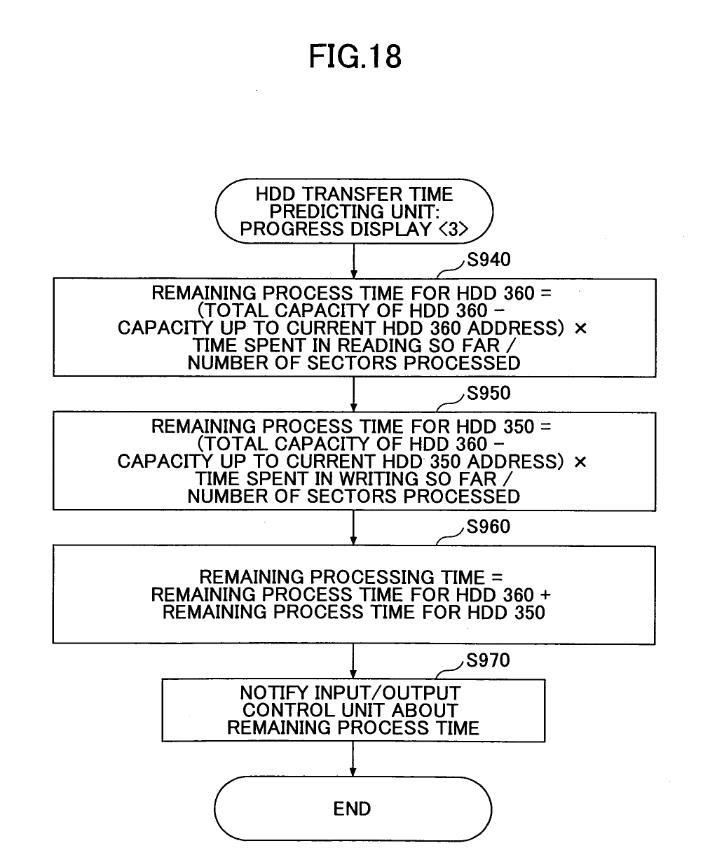

FIG. 18 depicts a flowchart of the progress display process <3> performed by the HDD transfer time predicting unit 220. First, the remaining process time of the HDD 360 is calculated as follows. The storage capacity up to the set HDD 350 address is subtracted from the total storage capacity of the HDD 360, and the difference is divided by the number of sectors that have been read up to the present time. The resultant quotient is then multiplied by the process time up to the present time (S940).

The remaining process time of the HDD 350 is calculated as follows. The storage capacity up to the set HDD 350 address is subtracted from the total storage capacity of the HDD 360, and the difference is divided by the number of sectors that have been read up to the present time. The resultant quotient is then multiplied by the process time up to the present time (S950). Thereafter, the remaining process time of the HDD 360 and the remaining process time of the HDD 350 are added, obtaining a total remaining time of the mirroring process (S960). Finally, the input/output control unit 270 is notified of the calculated remaining time, and a progress status is displayed on the CRT or the like (S970).

Thus, in accordance with various embodiments of the present invention, an information processing apparatus, an information processing method, and an information processing program are provided by which mirroring can be performed under less severe HDD conditions.

Although this invention has been described in detail with reference to certain embodiments, variations and modifications exist within the scope and spirit of the invention as described and defined in the following claims.

The present application is based on the Japanese Priority Application No. 2008-325944 filed Dec. 22, 2008, the entire contents of which are hereby incorporated by reference.

What is claimed is:

1. An information processing apparatus comprising:
a first storage unit;
a second storage unit connected to the first storage unit via a data transfer channel;
a HDD total capacity determination unit configured to acquire information about a total storage capacity of the first storage unit;
a HDD partition capacity determination unit configured to acquire information about a storage capacity in use of the second storage unit;
a comparison unit configured to compare the information about the total storage capacity of the first storage unit acquired by the HDD total capacity determination unit with the information about the storage capacity in use of the second storage unit acquired by the HDD partition capacity determination unit;
a copy determination unit configured to determine whether data stored in the second storage unit can be transferred to the first storage unit based on a result of comparison by the comparison unit; and
a copy processing unit configured to transfer the data stored in the second storage unit to the first storage unit when it is determined by the copy determination unit that the transfer is possible.

2. The information processing apparatus according to claim 1, wherein the second storage unit includes a storage area that is divided into a plurality of partitions in which the data of the second storage unit is stored,
wherein the copy processing unit is configured to select a method of transfer of the data stored in the plural partitions of the second storage unit depending on corresponding utilization ratios of the partitions of the second storage unit.

3. The information processing apparatus according to claim 2, wherein the first storage unit includes a storage area that is divided into a plurality of partitions in which the data of the first storage unit is stored,
wherein the copy processing unit is configured to transfer the data stored in the partitions of the second storage unit to the partitions of the first storage unit after setting the storage area of the partitions of the first storage unit to be smaller than the storage area of the partitions of the second storage unit.

4. The information processing apparatus according to claim 1, further comprising a HDD transfer time predicting unit configured to predict an end time of the transfer process by the copy processing unit based on an amount of data that has been transferred by the copy processing unit, an amount of data that has yet to be transferred by the copy processing unit, and a time required for the transfer of the data that has been transferred by the copy processing unit.

5. The information processing apparatus according to claim 1, wherein the copy processing unit is configured to transfer the data transferred from the second storage unit to the first storage unit back to the second storage unit.

6. An information processing method comprising:
acquiring information about a total storage capacity of a first storage unit;
acquiring information about a storage capacity in use of a second storage unit;
comparing the information about the total storage capacity of the first storage unit with the information about the storage capacity in use of the second storage unit;
determining whether data stored in the second storage unit can be transferred to the first storage unit based on a result of the comparing step; and
transferring the data stored in the second storage unit to the first storage unit when it is determined in the determining step that the data can be transferred.

7. The information processing method according to claim 6, wherein the second storage unit includes a storage area that is divided into a plurality of partitions in which the data of the second storage unit is stored,
the information processing method further comprising selecting a method of transfer of the data stored in the partitions of the second storage unit depending on corresponding utilization ratios of the partitions of the second storage unit.

8. The information processing method according to claim 7, wherein the first storage unit includes a storage area that is divided into a plurality of partitions in which data of the first storage unit is stored,
the information processing method further comprising setting the storage area of the first storage unit to be smaller than the storage area of the second storage unit, and then transferring the data stored in the partitions of the second storage unit to the partitions of the first storage unit.

9. The information processing method according to claim 6, further comprising predicting an end time of the transfer process in the transferring step based on an amount of data that has been transferred in the transferring step, an amount of data that has yet to be transferred in the transferring step, and a time required for the transfer of the data that has been transferred in the transferring step.

10. The information processing method according to claim 6, further comprising transferring the data transferred from the second storage unit to the first storage unit back to the second storage unit.

11. A computer-readable recording medium having an information processing program which, when executed by one or more processors of an information processing apparatus, carries out:
acquiring information about a total storage capacity of a first storage unit;
acquiring information about a storage capacity in use of a second storage unit;
comparing the information about the total storage capacity of the first storage unit with the information about the storage capacity in use of the second storage unit;
determining whether data stored in the second storage unit can be transferred to the first storage unit based on a result of the comparing step; and
transferring the data stored in the second storage unit to the first storage unit when it is determined in the determining step that the data can be transferred.
